(19) United States
(12) Patent Application Publication
(10) Pub. No.: US 2009/0308289 A1
(43) Pub. Date: Dec. 17, 2009

(54) SHIPPING PALLET

(75) Inventor: Tobi W. Ferguson, Lutz, FL (US)

Correspondence Address: KINNEY & LANGE, P.A., THE KINNEY & LANGE BUILDING, 312 SOUTH THIRD STREET, MINNEAPOLIS, MN, 55415-1002, US

(73) Assignee: James A. Donovan, Tarpon Springs, FL (US)

(21) Appl. No.: 12/546,803

(22) Filed: Aug. 25, 2009

Related U.S. Application Data
(63) Continuation-in-part of application No. 12/220,859, filed on Jul. 29, 2008.
Application No. 12/220,859 is a continuation-in-part of application No. 12/074,634, filed on Mar. 5, 2008.

(51) Int. Cl. B65D 19/34; B23P 11/00

(52) U.S. Cl. 108/51.3; 29/428

(57) ABSTRACT

A shipping pallet made from cardboard sheets. A pair of support beams are positioned under a pallet top. “L” shaped beams positioned inside each of the support boxes such that such that the ends of the “L” shape engage inner corners of the box and the bend in the “L” contacts the inner top surface of the box. A filler beam may be inserted inside the “L” shaped beam.

### CROSS-REFERENCE TO RELATED APPLICATION(S)

This application is a continuation-in-part of the Shipping Pallet application filed Jul. 29, 2008 having Ser. No. 12/220,859, which in turn is a continuation-in-part of the Shipping Pallet application filed Mar. 5, 2008, having Ser. No. 12/074,634.

### BACKGROUND

The present invention relates to shipping pallets. More particularly the present invention relates to pallets that are inexpensive to make, easy to store, and strong enough to support conventional loads.

Pallets have been used for many years as supports for a wide variety of goods. Pre-packaged in separate small units and secured atop individual pallets, goods can then be lifted and moved around with the use of fork lift trucks. Traditionally, pallets have been made entirely of wood, but such combinations are not only expensive to construct but also bulky to store and difficult to recycle. There is a need for low cost, easy to store and recyclable pallets. Pallets which can be easily fabricated in a wide range of custom sizes are also highly desirable.

Corrugated paper dates to the mid-19th century and corrugated paper for shipping pallets dates to the early 1970's in Japan. Most are based upon multiplying folded corrugated sheets to approximate the wooden stringers of conventional pallets.

Corrugated pallets have many advantages. Unlike wooden, plastic, or metal pallets, corrugated can be recycled at the recipient's location as paper/card board and does not have to be returned for reuse. Even so called “pallet pools” ship a lot of air.

There exists a need for simple corrugated pallet designs which are strong but do not require expensive multiple-step die cutting and folding steps, do not require excessive adhesive to assemble and which can be assembled at the user's site by minimally skilled laborers.

### SUMMARY

The present invention is a pallet device used for shipping objects like boxes and packages. The pallet device is formed from a first cardboard sheet having a front, a back and two sides, the two sides having pre-set folds such that the sides fold to form a box like beam at each side positioned under the sheet. The beams are fastened to the underside of the remaining part of the sheet. The pallet device may alternatively be formed from a cardboard pallet top having a front, a back and two sides. Additional cardboard sheets form at least two support boxes or beams and are positioned at each side of the pallet top. The support beams are fastened to the underside of the sheet. In either embodiment, the boxes are fastened to the underside of the sheet using an adhesive or glue. Preferably, a combination of a fast setting glue such as hot glue and a slow but much stronger setting glue such as cold glue is used to fasten the beams to the pallet top. The pallet is preferably formed from two ply cardboard or corrugated cardboard. For the purposes of this invention, cardboard and corrugated are interchangeable words for commercially available materials made from paper pulp. Other materials such as plastic and other synthetic materials are also within the scope of this invention.

Additional cardboard sheets are formed into two “L” or “V” shape beams. For the purposes of this invention, the terms “L” and “V” are the same. The “L” shape beams are sized to fit inside the support beams to provide additional support. Maximum strength is obtained when the ends of the “L” shape sheet engage inner corners of the beam, such as at the base of the beam, and the bend in the “L” contacts an inner surface of the beam, such as at the top of the beam. In this manner, downward forces from loads placed on the pallet are distributed from the pallet top to the rigid beam comers. Additional “L” or “V” beams may be added so as to create an accordion arrangement of support beams to provide added strength.

The first sheet includes pre-set folds formed by bending, creasing, cutting or scoring partly through the sheet at locations where the folds are to be made. Similarly, when the support beams are made from a separate sheet or sheets, pre-set folds may be used also.

More than one such pallet can be used in combination and they can be fastened together.

### BRIEF DESCRIPTION OF THE DRAWINGS

FIG. 1 is a perspective view of the present invention shown carrying a load.

FIG. 2 is a plan view of the preferred embodiment prior to assembly.

FIG. 3 is a side view of the embodiment of FIG. 2 being assembled.

FIG. 4 is a perspective view of the embodiment of FIGS. 2 and 3 being fitted with the other component of the device.

FIG. 5 is a perspective view showing an alternative embodiment of one component of the present invention.

FIG. 6 is a perspective view showing a different alternative embodiment of the present invention.

FIG. 7 is yet another embodiment of the present invention.

FIG. 8 is yet another embodiment of the present invention.

### DETAILED DESCRIPTION

As shown in the figures, a pallet device, 10 generally, is designed to carry a load, such as box 11. It is intended that any products or objects carried by conventional pallets can be used with the present invention. It is intended that the pallet device accommodate the use of fork lifts and other means for lifting, moving and storing pallets having product thereon.

Pallet 10 includes a top 13 with at least two support beams 15 extending from the front to the back of top 13 and are placed proximate each of the two sides. Also provided are at least two “L” shaped beams 17 and are sized to fit inside each one of the support beams 15.

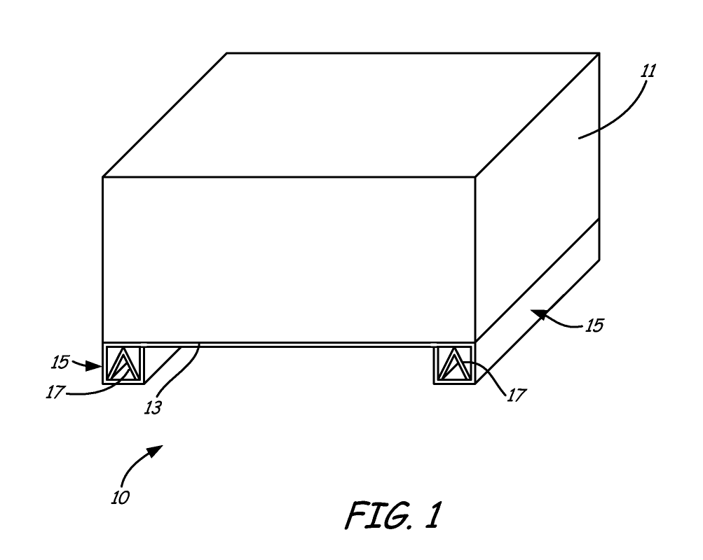

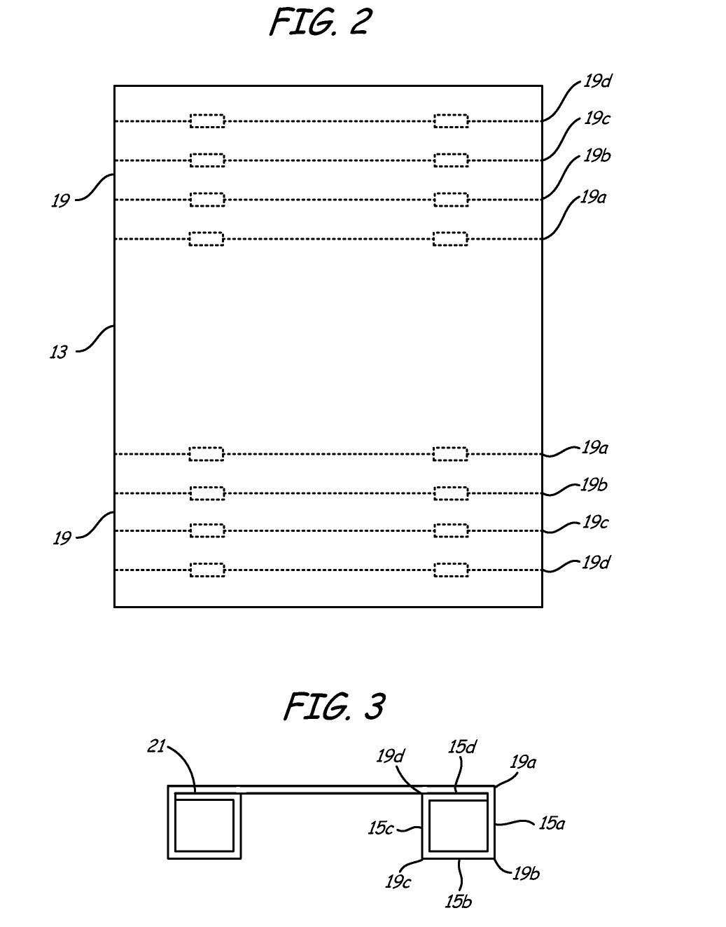

FIG. 2 illustrates the pallet 10 prior to assembly, with the top 13 being formed from a larger material with ends 19 extending out from the center portion forming top 13. Ends 19 have a series of folds 19a, 19b, 19c and 19d on each end that are folded to form support beams 15 of FIG. 1. FIG. 3 illustrates how the folds are used to form beam 15. The folds are formed by bending, creasing, cutting or scoring ends 19 along the width of pallet 10 such that the first fold forms side 15a, the second fold forms bottom 15b, the third fold forms side 15c and the fourth fold forms top 15d. This last surface 15d is attached to the bottom of top 13 with a fastener such as glue 21. While the ends 19 may be folded in either direction, it has been found that the beam 15 is stronger if the dents or folds 19a, etc. are on the outside of beam 15, as illustrated by the tie lines for 19a, etc. in FIG. 3. The term “score line” is intended to include any manner of forming the folds 19a etc., whether by bending, creasing, cutting, scoring or other means.

Glue is preferred as a fastener because it allows the pallet 10 to be recycled or re-pulped. For the purposes of this invention, glue is to be interpreted as a generic term for any substance that can be used to stick things together, and includes hot glue, cold glue, adhesives, liquid rubber, cement and the like. The glue may be liquid, gelatinous, in powder form or any common form for glue.

Any glue that is capable of bonding the material from which pallet 10 is constructed is within the scope of this invention. In one embodiment, hot glue is applied along with cold glue. The function of the hot glue is to hold top 15d against top 13 for sufficient time to allow a stronger but slower bonding glue to complete the permanent and strong bond needed. Hot glue is a form of thermoplastic adhesive sold in cylindrical sticks and melted in an electric glue gun as the glue is pushed through the glue gun. Ethylene-vinyl acetate copolymers are used as hot glue materials. Polypropylene, polyamides, polyethylene and the like are also used alone or as copolymers for a hot glue system. Most commercially available hot glue systems heat the glue to a tacky state that hardens relatively quickly, such as less than five seconds to as long as forty-five seconds or more.

The cold glue, if a second, stronger bond is needed, may be any commercially available glue. Cold glue may include cement, epoxy, paste, polyurethane, white glue, cyanoacrylate (also known as super glue) and other forms of glue or adhesives that bonds surfaces together. It is also contemplated that this stronger glue may be used alone without the benefit of a hot glue to hold it in contact until it sets. Some epoxy glues set up quite quickly and only that glue may be needed. One glue that has been successfully used is CORE-TITE® 32-36A, made by National Adhesives of Bridgewater, N.J.

Other fasteners are also contemplated, such as staples, stitches, and bands that encircle the junction of top 15d as it engages top 13.

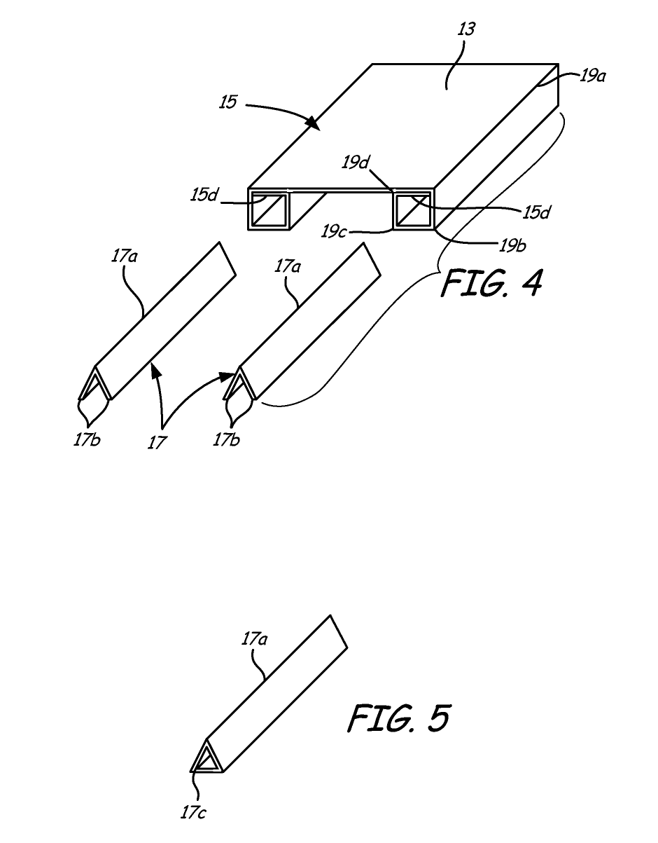

FIG. 4 illustrates the use of “L” shaped beams 17, where the ends of the “L” shaped beams 17b engage the inner comers of support beam 15 at 19b and 19c, and the bend 17a in the “L” contacts an inner surface 15d of support beam 15, preferably equally distant from the other two inner corners of support beam 15 defined by 19a and 19d. In another embodiment, “L” shaped beam 17 can have a third side 17c as seen in FIG. 5, thereby forming a triangle that has more rigidity.

The cardboard of this invention may be any conventional cardboard material, though two ply cardboard is preferred. In a preferred embodiment, the sheets are formed from corrugated cardboard such as 275# corrugated cardboard stock. Top sheet 13 can be any practical dimension. It is common to form pallets that are 48 inches deep and 40 inches wide. With that dimension, the support beams 15 will be the same length as the top sheet 13 and will be approximately 3.5 inches high and 3.625 inches wide, though any practical dimension can be used. The “L” shaped beams 17 are also the same length as top sheet 13 and support beam 15, and will be wide enough to engage two comers and the opposite inner surface of support beam 15, as shown in FIG. 1 and elsewhere. With the above dimensions for the support beam 15, the “L” shaped beam 17 will be 7.375 inches wide, folded in half as shown.

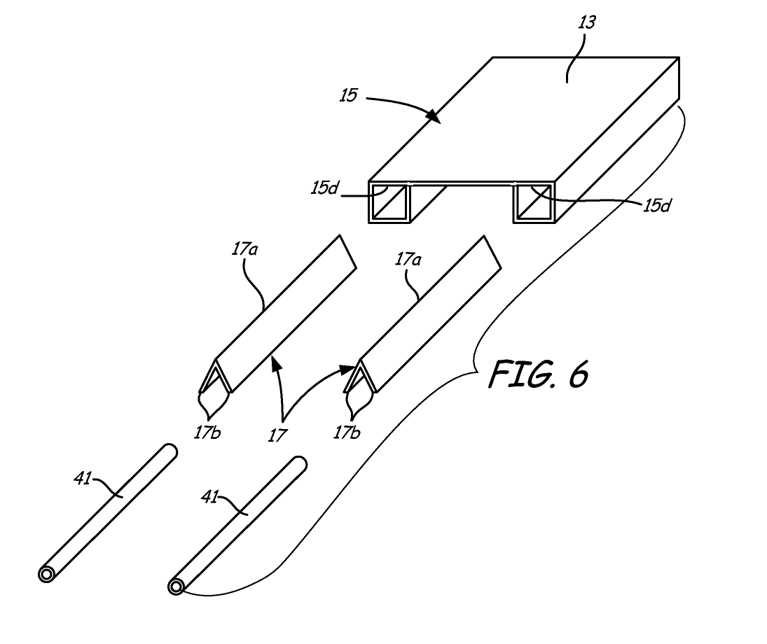

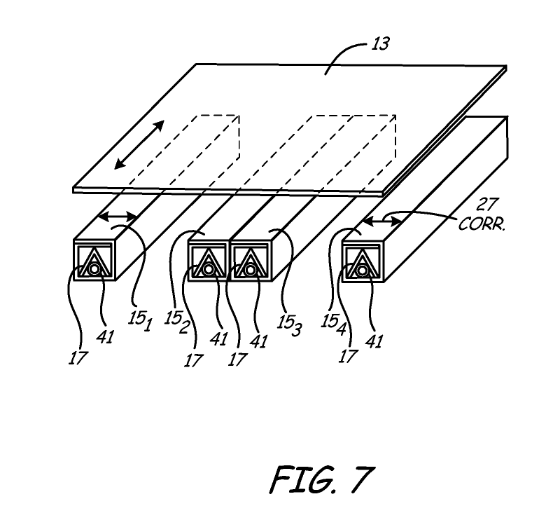

FIG. 6 illustrates an additional embodiment in which filler beams 41 are formed, preferably also from cardboard. Filler beams 41 are sized to fit inside the “L” shaped beams 17 as shown in FIG. 7.

FIG. 7 also illustrates an alternative embodiment with the use of two sets of support beams, 15₁ and 15₂ forming one pair and 15₃ and 15₄ forming a second pair, set side by side. This arrangement provides four support beams 15 and a shorter span for each pallet top 13. Beams 15 are spaced such that a conventional fork lift truck can engage the two pallets. Again, beams 15 are fastened to sheet 13 by a glue as noted above. When a load 11 is on the pallets, its weight adds stability to the pair of pallets.

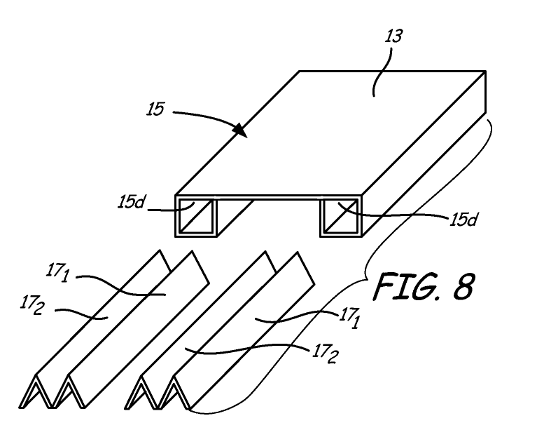

FIG. 8 illustrates yet another embodiment where two or more “L” shaped beams 17₁ and 17₂ are both inserted into support beam 15 in a variety of configurations. FIG. 8 illustrates the two “L” shaped beams 17₁ and 17₂ side by side, so that when inserted each one will contact a corner of support beam 15 and both will contact the top 15d of support beam 15 as well as contacting each other at the side that does not contact a support beam corner. It is intended that “L” shaped beams 17₁ and 17₂ may be inserted in other configurations, such as with the open ends facing each other. It is also intended that three or more “L” shaped beams 17 may be used in each support beam 15.

Because of the strength of the pallets 10 of this invention, they are capable of holding loads essentially equal to the loads held by conventional wood pallets. Pallets 10 according to this invention have held more than 2,500 pounds. Because the “L” shaped beams 17 stabilize support beams 15, pallets 10 can be stacked as high as needed.

In another embodiment, pallets 10 can be sprayed or otherwise coated with water proofing compounds or weather protecting coatings. This can be done during the pulping process or when the product is made or about to be assembled. Pallets 10 can also be treated for mildew or mold resistant agents, again at any point in the process of manufacture.

In production, pre-folds on the cardboard components may be made and the pre-formed pallets may be shipped or delivered to the user lying flat to take up the least amount of space. They can then be easily assembled by dock workers or other personnel at the site where the objects are to be loaded. Because the pallets are made from cardboard, they can be recycled, thus eliminating any expense in returning them, or they can be dis-assembled for shipping as flat cardboard if it is deemed necessary to reuse them. When an environmentally safe glue is used, no staples or other mental components need to be removed, saving labor and eliminating risks of injury from sharp staples. Thus considerable economic savings are achieved with the present invention, both in material and shipping costs as well as environmental savings using recyclable materials.

Although the present invention has been described with reference to preferred embodiments, workers skilled in the art will recognize that changes may be made in form and detail without departing from the spirit and scope of the invention.

1. A pallet device, comprising:
a flat pallet top formed from cardboard and having a front, a back and two sides;
at least two support beams formed from cardboard, one of the at least two thus formed support beams mounted under the pallet top proximate each of the two sides and under the pallet top and fastened thereto by at least one glue;
at least two “L” shaped beams formed from cardboard and each being sized to fit inside one of the support beams such that such that the ends of the “L” shape engage inside corners of the support beam and the bend in the “L” contacts an inner surface of the support beam.

2. The device of claim 1, wherein the pallet top, support beam and “L” shaped beam are formed from two-ply cardboard.

3. The device of claim 1, wherein the pallet top includes fold lines at its two sides for forming the support beams from the sides thereof.

4. The device of claim 3, wherein the “L” shaped beams are folded to form the support beams with the fold lines on the outside of the folds.

5. The device of claim 1, wherein the support beams have a square cross section.

6. The device of claim 1, wherein the “L” shaped beams further include a third portion forming a triangular beam.

7. The device of claim 1, which further includes filler beams having a shape selected from square, round and triangular, wherein a filler beam is positioned inside each “L” shaped beam.

8. A pallet device, comprising:
a pallet top means for supporting packages and having a front, a back and two sides;
at least two cardboard support beam means, one of the at least two support beams means being mounted under the pallet top means proximate each of the two sides and fastened thereto by glue means for fastening the support beam means to the pallet top means;
at least two “L” shaped beams means with each being sized to fit inside one of the support beam means such that such that the ends of the “L” shape beam means engage inner corners of the support beam and the bend in the “L” contacts an inner surface of the support beam means.

9. The device of claim 8, wherein the pallet top means, support beam means and “L” shaped beam means are formed from two ply cardboard.

10. The device of claim 8, the pallet top means includes fold means at its two sides for for forming the support beam means from the sides thereof

11. The device of claim 8, wherein the “L” shaped beam means are folded to form the support beam means with the fold means on the outside of the “L” shaped beam means.

12. The device of claim 8, wherein the “L” shaped beam means further include a third portion forming a triangular beam means.

13. The device of claim 8, which further includes at least one filler beam means for every “L” shaped beam means and positioned inside the “L” and sized to contact both sides of the “L” shaped beam means and the support beam means on its side opposite the bend of the “L” shaped beam means.

14. The device of claim 13, wherein the filler beam means has a shape selected from square, round and triangular.

15. A method for making a pallet device, comprising the steps of:
selecting a pallet top having a front, a back and two sides;
forming at least two support beams mounting one of the at least two support beams under the pallet top proximate each of the two sides and fastening the two support means to the pallet top by at least one glue;
forming at least two “L” shaped beams, each third sheet “L” beams being sized to fit inside one of the support beams, and placing each third sheet “L” beam inside a support beam such that such that the ends of the “L” shape engage inner corners of the support beam and the bend in the “L” contacts an inner surface of the support beam.

16. The method of claim 15, wherein the pallet top, support beams and “L” shaped beams are formed from two ply cardboard.

17. The method of claim 15, wherein the sides of the top are folded to form the support beams with the fold lines on the outside of the folds.

18. The method of claim 15, wherein the “L” shaped beams further include a third portion forming a triangular beam.

19. The method of claim 15, which further includes forming at least one filler beam for every “L” shaped beam sized to contact both sides of the “L” shaped beam and the support beam on its side opposite the bend of the “L” shaped beam, and positioning a filler beam inside each “L” shaped beam.

20. The method of claim 19, wherein the fourth sheet is formed into a filler beam having a shape selected from square, round and triangular.
